(19) United States
(12) Patent Application Publication
(10) Pub. No.: US 2010/0125932 A1
(43) Pub. Date: May 27, 2010

(54) MARTIAL ARTS STUDENT IDENTIFICATION SYSTEM

(76) Inventors: RAHMI HALK, Brick, NJ (US); Paul Prendergast, Brick, NJ (US)

Correspondence Address: MICHAEL R. KAHN, P.O. BOX 184, MOUNT HOLLY, NJ, 08060, US

(21) Appl. No.: 12/621,477

(22) Filed: Nov. 18, 2009

Related U.S. Application Data
(60) Provisional application No. 61/199,909, filed on Nov. 21, 2008.

(51) Int. Cl. A41F 9/00; G08B 13/14; G06K 5/00; G06K 19/02; G06K 19/06; G06F 15/00

(52) U.S. Cl. 2/338; 340/572.1; 235/380; 235/488; 235/492; 235/494; 358/1.15

(57) ABSTRACT

A martial arts student identification system is disclosed. The ID card is removably mounted to the belt. The ID card can be removed from the belt if it needs to be washed, or for when the student advances to a new belt. In one embodiment, a hook-and-loop fastener, such as VELCRO, is used to affix the ID card to the belt.

### RELATED APPLICATIONS

This application claims benefit to U.S. Provisional Application Ser. No. 61/199,909 filed on Nov. 21, 2008.

### FIELD OF THE INVENTION

The present invention relates to attendance tracking, and more specifically, to attendance tracking for students of martial arts schools.

### BACKGROUND

Schools for the martial arts have proliferated in recent years. Statistics indicate that there are over 30,000 schools across the United States, with a combined total of about four million students enrolled. The increased interest in the martial arts has necessitated solutions for managing the students. In particular, there is a need to record attendance, in part to keep track of tuition to be billed, as well to ensure sufficient attendance for belt advancement. To that end, a variety of martial arts attendance systems are commercially available. For example, Martial Arts Organizer, available from www.martialartsorganizer.com provides a software solution that enables a user to create a photo ID card, with a corresponding barcode. Upon entering the martial arts school, each student has their ID card scanned by a barcode scanner. However, the current ID cards have various shortcomings. Therefore, it is desirable to have an improved martial arts student identification system.

### SUMMARY OF THE INVENTION

As stated above, there are various shortcomings with the current ID cards. Primarily, students often forget them, leading to inaccurate attendance, or in some cases, preventing the student from training that day. Many martial art students are children, and therefore may be more prone to losing an ID card. Often the parent carries the ID card for the child, and if another person takes the child to the martial arts school, there is an increased chance that the card will be forgotten.

These problems can be eliminated if the ID card is actually worn on the uniform. However, this creates other challenges. First, the ID card should not interfere with movement due to practicing martial arts moves, or sparring. Second, the uniform should be frequently washed, so anything attached to the uniform itself must be able to withstand washing. Embodiments of the present invention overcome these challenges with a novel approach. With embodiments of the present invention, the ID card is removably mounted to the belt. In most cases, the belts are not washed. Therefore, by mounting the ID card on the belt, the issue of washing is largely eliminated. However, the ID card can be removed from the belt if it needs to be washed, or for when the student advances to a new belt. The martial arts identification card of embodiments of the present invention is considerably smaller than those in current use. A hook-and-loop fastener, such as VELCRO, is used to affix the ID card to the belt. One part of the hook-and-loop fastener is affixed to the belt, and the complementary hook-and-loop fastener is affixed to the ID card. In this way, the ID card is always with the uniform, and hence always with the student. This eliminates the attendance issues that are present in the current systems. This will be further explained in the detailed description that follows.

### BRIEF DESCRIPTION OF THE DRAWINGS

FIG. 1 shows a user with an embodiment of the present invention.

FIG. 2 shows a detailed view of an embodiment of the present invention.

FIG. 3 shows a view of an alternative embodiment of the present invention.

FIG. 4 shows a view of another alternative embodiment of the present invention.

FIG. 5 shows a side view of the embodiment shown in FIG. 2.

FIG. 6 shows a block diagram of a system in accordance with an embodiment of the present invention.

### DETAILED DESCRIPTION

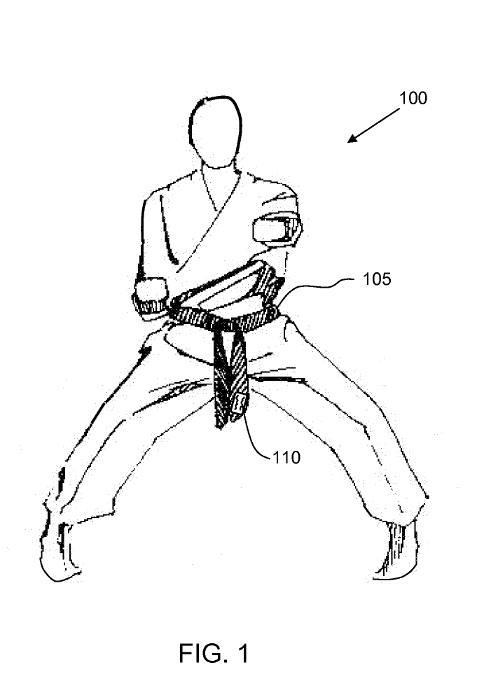

FIG. 1 shows a user 100 with an embodiment of the present invention. As is common in martial arts, the user is wearing a belt 105. Belt 105 is comprised of a strip of fabric. Affixed to belt 105 is ID card 110.

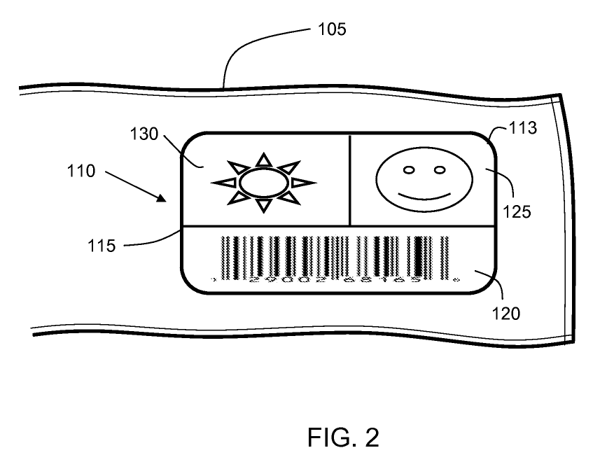

FIG. 2 shows a detailed front surface view of an embodiment of the present invention. As is shown in this view, ID card 110 is attached to belt 105, preferably towards one end of the belt 105. ID card 110 may comprise a photo 125, school logo 130 (or other icon), and a computer-readable identifier 120. In this case, identifier 120 is a barcode. However, a data matrix, or other suitable optical identifier may also be used as computer-readable identifier 120. Optionally, a dividing line 115 may be used to visually separate the barcode 120 from other graphical components, such as photo 125 and logo 130. In one embodiment, ID card 110 has rounded corners 113, which minimize the risk of the ID card 110 getting snagged on something during sparring or training. In another embodiment, the ID card has a width ranging from about 3 centimeters (cm) to about 5 cm, and a height ranging from about 2 cm to about 3 cm. This embodiment of the present invention is considerably smaller than those in current use, and is suitable for the novel approach of affixing the ID card to the martial arts belt.

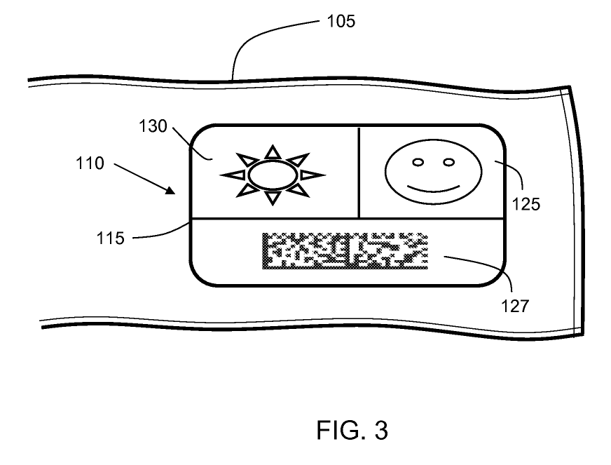

FIG. 3 shows a view of an alternative embodiment of the present invention. In this embodiment, computer-readable identifier 127 is a data matrix. The advantage of a data matrix is that it can store considerably more data than a barcode. In some cases, a data matrix may be capable of storing a few kilobytes of data. This provides the possibility to store more information pertaining to a martial arts student than with a barcode. For example, the school name and date of birth of the student can be encoded into the data matrix. This embodiment is well suited for tournaments, where students of various schools and of various ages gather to compete. By scanning the ID cards, this information could be tracked by computer for tournament purposes.

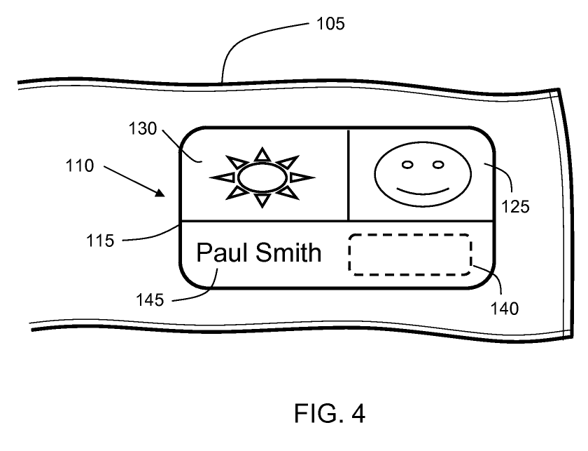

FIG. 4 shows a view of another alternative embodiment of the present invention. In this embodiment, a student name field 145 is displayed on the ID card 110. Instead of using an optical computer-readable identifier as with the previous two embodiments, this embodiment uses a radio identifier, such as an RFID tag 140, which is embedded into the label. In this embodiment, optical scanning is not required, and it is possible to record the student's attendance by mounting an RFID reader in the proper position at the entrance to the school. In this way, the issue of forgetting to scan a student's ID card is solved. While this embodiment shows an embedded RFID tag, a chipless RFID tag which is printed directly on the ID card 110 could also be used to practice an embodiment of the present invention. Various companies provide RFID solutions for clothing tags, such as Checkpoint Systems, Inc. of Thorofare, N.J.

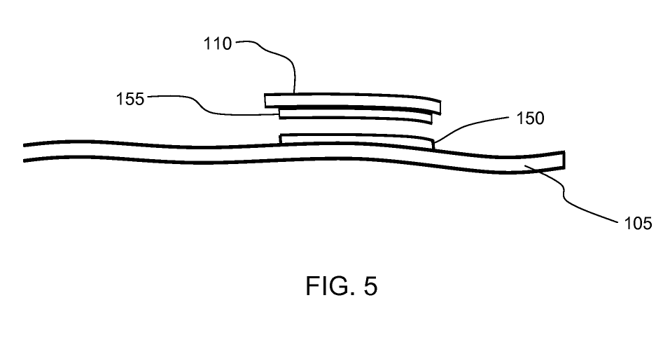

FIG. 5 shows a side view of the embodiment shown in FIG. 2. In this embodiment, a loop part 150 of a complementary hook-and-loop fastener is affixed to the belt 105. In one embodiment, loop part 150 is attached to belt 105. In one embodiment, loop part 150 is an industrial strength, heavy duty adhesive, self-stick fastener. The user simply affixes it onto the belt. Alternatively, the loop part 150 may also be sewn to the belt 105. Hook part 155 of the complementary hook-and-loop fastener is affixed to ID card 110 via a similar self-stick means as described above. The loop part 150 tends to be softer than the hook part 155, and hence, the loop part 150 is preferable to affix to belt 105. However, it is also possible to affix hook part 155 to belt 105, and loop part 150 to ID card 110, without departing from the scope and purpose of the present invention.

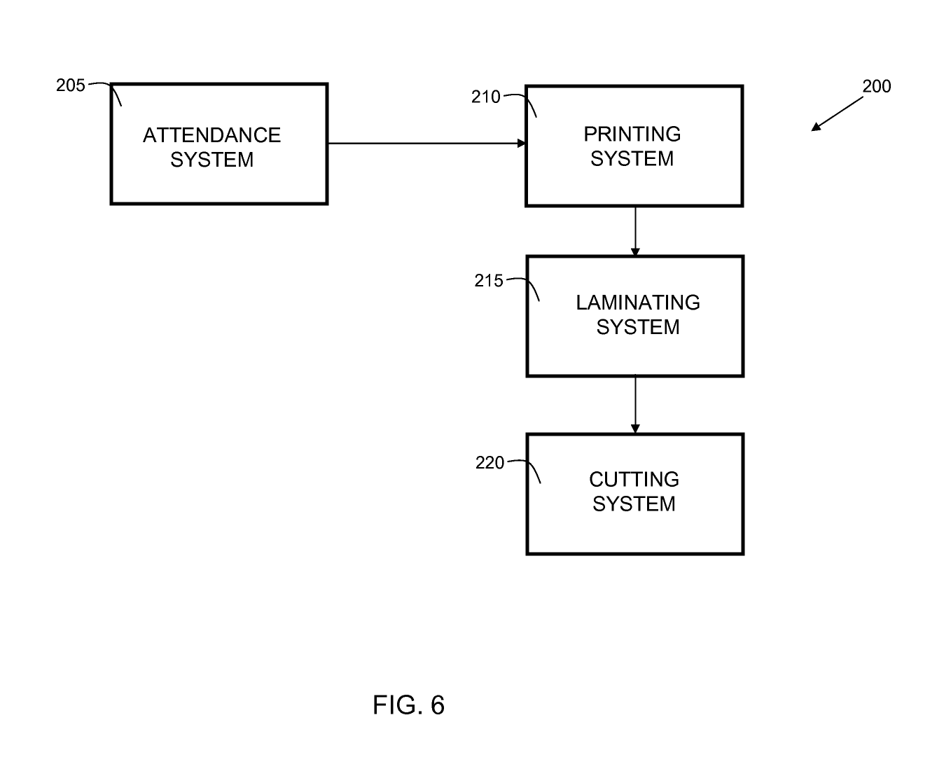

FIG. 6 shows a block diagram of a martial arts student identification system 200 in accordance with an embodiment of the present invention. Attendance system 205 is preferably located at the martial arts school. There, new students are photographed, and a record is entered into the attendance system 205 for the student. The attendance system generates a student number, and encodes that number into a barcode. The barcode, photo, and student name are uploaded to the printing system 210. The printing system 210 may be in a different physical location than the attendance system 205. In one embodiment, the attendance system 205 communicates to the printing system 210 via a data communication network such as the Internet. The ID card is then printed. The ID card is preferably made of durable plastic, ranging in thickness from about 25 mils to about 35 mils. In one embodiment, ID card 110 is a 30 mil PVC plastic card, such as the DATACARD 803094-001, distributed by Datacard Group, of Minnetonka, Minn.

After printing the desired images on the ID card, a laminate is applied to the front surface of ID card by laminating system 215. In one embodiment, printing system 210 and laminating system 215 are integrated into a single device, such as the Datacard ImageCard II printer. In this embodiment, the lamination is performed by using a clear topcoat ribbon, such as the Datacard 806125-103 ribbon. The clear topcoat lamination serves to protect the ID card, and reduce scratches, which might impact the readability of the barcode or other optical identifier.

Once laminated, the ID cards are then cut out by cutting system 220. In one embodiment, cutting system 220 comprises a heavy duty plastic die cutter. Suitable die cutters are available from a variety of sources, such as Union Brothers, of Gardena, Calif. Note that while this embodiment shows the ID cards being cut after being printed, it is also possible to precut the labels, and then print them, if the equipment supports that, without departing from the scope and purpose of the present invention.

As can now be appreciated, embodiments of the present invention provide for an improved martial arts student identification system that overcome problems associated with prior art systems.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components, the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A martial arts belt, comprising:
a strip of fabric;
an identification card, said identification card removably attached to the strip of fabric at one end, wherein the identification card comprises a computer-readable identifier.

2. The martial arts belt of claim 1, wherein the computer-readable identifier comprises a barcode.

3. The martial arts belt of claim 1, wherein the computer-readable identifier comprises an RFID tag.

4. The martial arts belt of claim 1, wherein the computer-readable identifier comprises a data matrix.

5. The martial arts belt of claim 1, wherein the identification card further comprises a photo.

6. The martial arts belt of claim 1, wherein the identification card further comprises a logo.

7. The martial arts belt of claim 1, wherein the identification card is formed from plastic, and ranges in thickness from about 25 mils to about 35 mils.

8. The martial arts belt of claim 7, wherein the identification card further comprises a clear topcoat lamination.

9. The martial arts belt of claim 1, wherein the strip of fabric comprises a hook-and-loop fastener at one end, and wherein the identification card comprises a complementary hook-and-loop fastener, thereby serving to removably affix the identification card to the strip of fabric.

10. A martial arts student identification system, comprising:
an attendance system, the attendance system comprising at least one computer;
a printing system, the printing system configured to receive student data from the attendance system, and to print an identification card based on the received student data;
a laminating system, the laminating system configured and disposed to receive the identification card from the printing system; and
a cutting system, the cutting system configured and disposed to receive the identification card from the laminating system.

11. The system of claim 10, wherein the printing system and lamination system comprise a Datacard ImageCard II printer.

12. A martial arts identification card, comprising:
a plastic card, the card ranging in thickness from about 25 mils to about 35 mils;
a computer-readable identifier;
a clear topcoat lamination layer disposed on the front surface of the plastic card.

13. The martial arts identification card of claim 12, wherein the computer-readable identifier is a barcode.

14. The martial arts identification card of claim 12, wherein the computer-readable identifier is a data matrix.

15. The martial arts identification card of claim 12, wherein the computer-readable identifier is an RFID tag.

16. The martial arts identification card of claim 13, further comprising a photo.

17. The martial arts identification card of claim 16, further comprising an icon.

18. The martial arts identification card of claim 17, further comprising a hook-and-loop fastener disposed on one side of the identification card.

19. The martial arts identification card of claim 13, further comprising rounded corners.

20. The martial arts identification card of claim 19, wherein the width of the card ranges from about 3 centimeters to about 5 centimeters, and the height of the card ranges from about 2 centimeters to about 3 centimeters.
